(19) United States
(12) Patent Application Publication
(10) Pub. No.: US 2013/0197903 A1
(43) Pub. Date: Aug. 1, 2013

(54) RECORDING SYSTEM, METHOD, AND DEVICE

(71) Applicant: WEN-HUI ZHANG, Shenzhen City (CN)

(72) Inventor: WEN-HUI ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/564,736

(22) Filed: Aug. 2, 2012

(30) Foreign Application Priority Data
Feb. 1, 2012 (CN) 201210022348.1

(51) Int. Cl. G10L 21/00

(52) U.S. Cl. 704/201; 704/E15.043; 704/E21.001

(57) ABSTRACT

An exemplary recording method receives the personal information of a speaker transmitted from a RFID tag through a RFID reader. Then the method receives the voice of the speaker through a microphone. The method next receives the personal information of the speaker and the identifier of the audio input device transmitted from the audio input device, and associates the personal information of the speaker with the received identifier of the audio input device. Then, the method receives the voice and the identifier of the audio input device transmitted from the audio input device. The method further converts the received voice to text. The method determines the personal information corresponding to the identifier of the audio input device received with the voice, and associates the converted text with the determined personal information to generate a record.

### BACKGROUND

1. Technical Field

The present disclosure relates to recording systems, and particularly, to a recording system capable of recording individual voices of each speaker in a conference.

2. Description of Related Art

Voice-recording or video-recording is a conventional method to record individual voices of each speaker in a conference. However, after the conference, when a user wants to obtain the voice of one specific speaker on a topic, the user often has to listen/see through the tape/video from beginning to end, which is time consuming.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram illustrating a recording system in accordance with an exemplary embodiment.

FIG. 2 is a block diagram of the recording system of FIG. 1.

FIG. 3 is a flowchart of a recording method in accordance with an exemplary embodiment.

### DETAILED DESCRIPTION

The embodiments of the present disclosure are described with reference to the accompanying drawings.

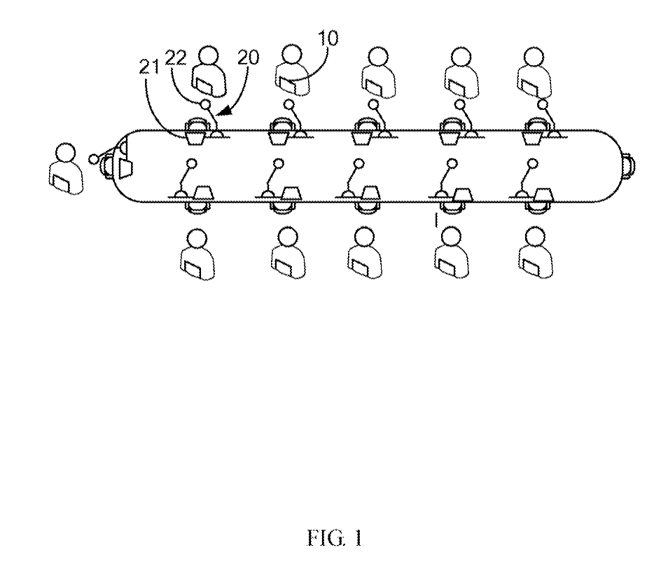

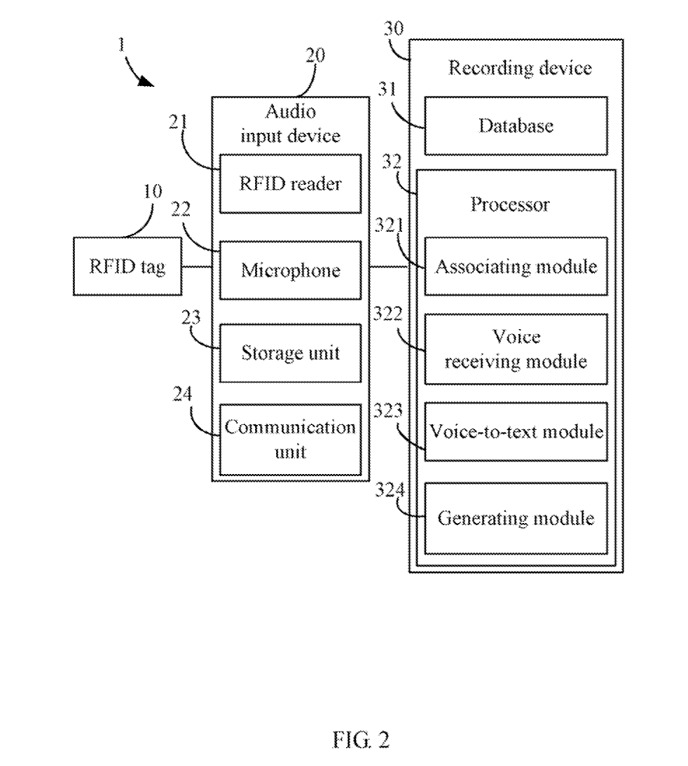

FIGS. 1-2 illustrate a recording system 1 in accordance with one embodiment. The recording system 1 includes a number of Radio Frequency Identification (RFID) tags 10, a number of audio input devices 20, and a recording device 30. Each RFID tag 10 is taken along by one speaker. The audio input device 20 can communicate with the RFID tag 10 through RFID technology. The audio input device 20 can communicate with the recording device 30 through the wireless or wired method.

Each RFID tag 10 stores personal information of one speaker who takes along the corresponding RFID tag, such as name, and photo, for example. Each RFID tag 10 includes an inner antenna for communication. In the embodiment, each RFID tag 10 is a passive RFID tag. In some embodiments, each RFID tag 10 can be semi-passive RFID tag, or active RFID tag.

Each audio input device 20 includes a RFID reader 21, a microphone 22, a storage unit 23, and a communication unit 24. Each RFID reader 21 includes one inner antenna or one outside antenna to communicate with the inner antenna of the RFID tag 10. The microphone 22 is configured to receive individual voices of the speaker. The storage unit 23 stores the identifier of the corresponding audio input device 20. The identifier of the audio input device 20 can be an identifier of the RFID reader 21, an identifier of the microphone 22, or an identifier of the communication unit 24. The audio input device 20 communicates with the recording device 30 through the communication unit 24. When the RFID reader 21 receives the personal information transmitted from the RFID tag 10, the RFID reader 21 transmits the personal information and the identifier of audio input device 20 through the communication unit 24 to the recording device 30. When the microphone 22 receives the voice of one speaker, the RFID reader 21 transmits the voice and the identifier of audio input device 20 through the communication unit 24 to the recording device 30.

The recording device 30 includes a database 31 and a processor 32. The processor 32 includes an associating module 321, a voice receiving module 322, a voice-to-text module 323, and a generating module 324.

When the distance between the RFID tag 10 and the RFID reader 21 of the audio input device 20 is in a predetermined range, namely, the speaker taking along with the RFID tag 10 uses the audio input device 20, the RFID tag 10 transmits the stored personal information of the speaker to the RFID reader 21 of the audio input device 20.

The RFID reader 21 of the audio input device 20 receives the personal information of the speaker transmitted from the RFID tag 10 and transmits the received personal information of the speaker and the stored identifier of the audio input device 20 through the communication unit 24 to the recording device 30.

The associating module 321 of the recording device 30 is configured to receive the personal information of the speaker and the identifier of the audio input device 20 transmitted from the audio input device 20, and associate the personal information of the speaker with the received identifier of the audio input device 20. Thus, the voice received by the audio input device 20 can be identified and mapped to the speaker according to the associated personal information.

The voice receiving module 322 of the recording device 30 receives the voice and the identifier of the audio input device 20 transmitted from the audio input device 20.

The voice-to-text module 323 of the recording device 30 converts the received voice to text.

The generating module 324 of the recording device 30 is configured to determine the personal information corresponding to the identifier of the audio input device 20 received with the voice according to the association between the personal information and the identifier of the audio input device 20, associate the converted text with the determined personal information to generate a record recording the text and the corresponding personal information, and further store the generated record to the database 31.

For example, when the RFID tag 10 taken along by the speaker A is adjacent to the audio input device B, the RFID tag 10 taken along by the speaker A transmits the stored personal information of the speaker A to the RFID reader 21 of the audio input device B. The RFID reader 21 of the audio input device B transmits the received personal information of the speaker A and the identifier of the audio input device B through the communication unit 24 to the recording device 30. The associating module 321 of the recording device 30 associates the personal information of speaker A with the identifier of the audio input device B, thus the voice received by the microphone 22 of the audio input device A represents the voice of the speaker A. When the speaker A speaks, the voice receiving module 322 of the recording device 30 receives the voice of the speaker A and the identifier of the audio input device B. The voice-to-text module 323 converts the received voice of the speaker A to the text A. The generating module 324 determines the personal information of the speaker A corresponding to the identifier of the audio input device B received with the voice, and further associates the determined personal information of the speaker A with the converted text A to generate a record for example, such as, speaker: speaker A; speaking content: text A.

In the embodiment, the voice receiving module 322 further records the speaking time of the received voice. The generating module 324 generates the record of the recording of the speaking time, the converted text, and the corresponding person information according to the recorded speaking time, the converted text, and the association between the text and the personal information. For example, when the speaker is A, the speaking time of the voice is 9:00-9:29, and the text converted from the voice of the speaker A is text A, the generating module 324 generates a record: speaking time: 9:00-9:29; speaker: speaker A; speaking content: text A.

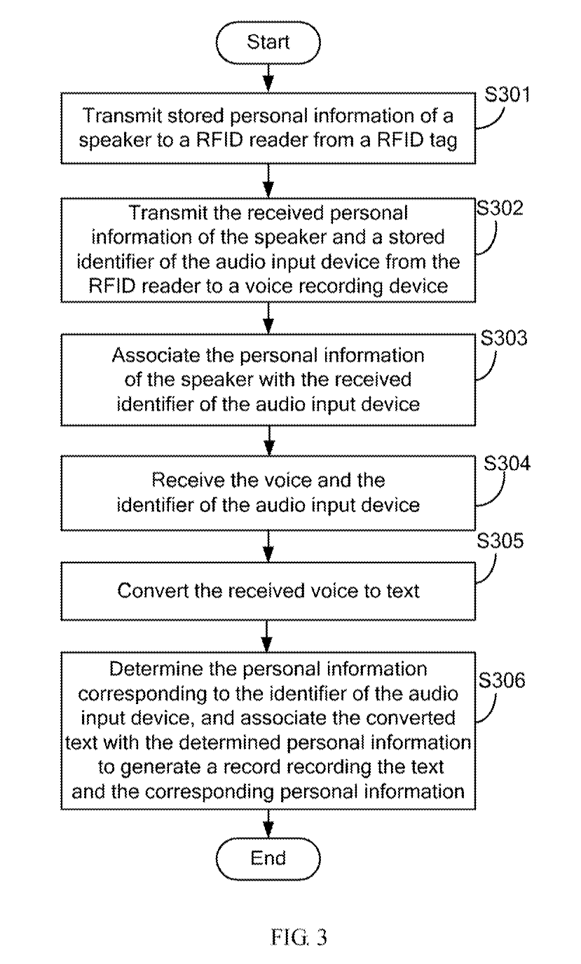

FIG. 3 shows a recording method in accordance with an exemplary embodiment.

In step S301, the RFID tag 10 transmits the stored personal information of the speaker to the RFID reader 21 of the audio input device 20 when the distance between the RFID tag 10 and the RFID reader 21 of the audio input device 20 is in a predetermined range.

In step S302, the RFID reader 21 of the audio input device 20 receives the personal information of the speaker transmitted from the RFID tag 10 and transmits the received personal information of the speaker and the stored identifier of the audio input device 20 through the communication unit 24 to the recording device 30.

In step S303, the associating module 321 of the recording device 30 receives the personal information of the speaker and the identifier of the audio input device 20 transmitted from the audio input device 20, and associates the personal information of the speaker with the received identifier of the audio input device 20.

In step S304, the voice receiving module 322 of the recording device 30 receives the voice and the identifier of the audio input device transmitted from the audio input device 20.

In step S305, the voice-to-text module 323 of the recording device 30 converts the received voice to text.

In step 306, the generating module 324 of the recording device 30 determines the personal information corresponding to the identifier of the audio input device 20 received with the voice according to the association between the personal information and the identifier of the audio input device 20, associates the converted text with the determined personal information to generate a record recording the text and the corresponding personal information, and further stores the record to the database 31.

In the embodiment, the voice receiving module 322 further records the speaking time of the voice. The generating module 324 further generates the record recording the speaking time, the text and the corresponding person information according to the recorded speaking time, the converted text, and the association between the text and the personal information.

Although the present disclosure has been specifically described on the basis of an exemplary embodiment thereof, the disclosure is not to be construed as being limited thereto. Various changes or modifications may be made to the embodiment without departing from the scope and spirit of the disclosure.

What is claimed is:

1. A recording system comprising:
at least one RFID tag, each of the at least one RFID tag storing personal information of a speaker;
at least one audio input device, each of the at least one audio input device comprising:
a microphone to receive the voice of the speaker using the audio input device;
a storage unit storing an identifier of the audio input device;
a RFID reader to receive the personal information of the speaker using the audio input device transmitted from the corresponding RFID tag storing the personal information; and
a communication unit to transmit the personal information of the speaker and the identifier of the audio input device, and transmit the voice received by the microphone and the identifier of the audio input device; and
a recording device comprising:
an associating module to receive the personal information of the speaker and the identifier of the audio input device transmitted via the communication unit of the audio input device, and associate the personal information of the speaker with the received identifier of the audio input device transmitted from the audio input device;
a voice receiving module to receive the voice and the identifier of the audio input device transmitted via the communication unit of the audio input device;
a voice-to-text module to convert the received voice to text; and
a generating module to determine the personal information corresponding to the identifier of the audio input device received with the voice according to the association between the personal information and the identifier of the audio input device, associate the converted text with the determined personal information to generate a record recording the text and the corresponding personal information.

2. The recording system as described in claim 1, wherein each of the at least one RFID tag is selected from a group consisting of a passive RFID tag, a semi-passive RFID tag, and an active RFID tag.

3. The recording system as described in claim 1, wherein the identifier of the audio input device is selected from a group consisting of an identifier of the RFID reader, an identifier of the microphone, and an identifier of the communication unit.

4. The recording system as described in claim 1, wherein the voice receiving module further records the speaking time of the voice, the generating module generates the record recording the speaking time, the text, and the corresponding person information according to the recorded speaking time, the converted text, and the association between the text and the personal information.

5. A recording method implemented by a recording system, the recording system comprising at least one RFID tag, at least one audio input device, and a recording device, the at least one RFID tag storing personal information of a speaker, each of the at least one audio input device comprising a microphone, a storage unit, a RFID reader, and a communication unit, the storage unit storing an identifier of the audio input device, wherein the method comprises:
receiving the personal information of the speaker using the audio input device transmitted from the corresponding RFID tag storing the personal information through the RFID reader;
transmitting the personal information of the speaker and the identifier of the audio input device via the communication unit;
receiving the personal information of the speaker and the identifier of the audio input device transmitted via the communication unit of the audio input device, and associating the personal information of the speaker with the received identifier of the audio input device transmitted from the audio input device;
receiving the voice of the speaker through the microphone;
transmitting the voice received by the microphone and the identifier of the audio input device via communication unit;
receiving the voice and the identifier of the audio input device transmitted via the communication unit of the audio input device;
converting the received voice to text; and
determining the personal information corresponding to the identifier of the audio input device received with the voice according to the association between the personal information and the identifier of the audio input device, and associating the converted text with the determined personal information to generate a record recording the text and the corresponding personal information.

6. The recording method as described in claim 5, wherein each of the at least one RFID tag is selected from a group consisting of a passive RFID tag, a semi-passive RFID tag, and an active RFID tag.

7. The recording method as described in claim 5, wherein the identifier of the audio input device is selected from a group consisting of an identifier of the RFID reader, an identifier of the microphone, and an identifier of the communication unit.

8. The recording method as described in claim 5, wherein the method further comprises:
recording the speaking time of the received voice; and
generating the record recording the speaking time, the text, and the corresponding person information according to the recorded speaking time, the converted text, and the association between the text and the personal information.

9. A recording device comprising:
an associating module to receive the personal information of a speaker and the identifier of an audio input device transmitted from an audio input device, and associate the personal information of the speaker with the received identifier of the audio input device transmitted from the audio input device;
a voice receiving module to receive the voice and the identifier of the audio input device transmitted from the audio input device;
a voice-to-text module to convert the received voice to text; and
a generating module to determine the personal information corresponding to the identifier of the audio input device received with the voice according to the association between the personal information and the identifier of the audio input device, and associate the converted text with the determined personal information to generate a record recording the text and the corresponding personal information.

10. The recording device as described in claim 9, wherein the identifier of the audio input device is selected from a group consisting of an identifier of the RFID reader, an identifier of the microphone, and an identifier of the communication unit.

11. The recording device as described in claim 9, wherein the voice receiving module further records the speaking time of the voice, the generating module generates the record recording the speaking time, the text, and the corresponding person information according to the recorded speaking time, the converted text, and the association between the text and the personal information.
